(19) United States
(12) Patent Application Publication
(10) Pub. No.: US 2016/0342774 A1
(43) Pub. Date: Nov. 24, 2016

(54) METHOD OF CO-LOCATED SOFTWARE OBJECT SHARING FOR MULTI-PLAYER AUGMENTED REALITY GAMES

(71) Applicant: CastAR, Inc., Palo Alto, CA (US)

(72) Inventors: David HENKEL-WALLACE, Palo Alto, CA (US); Ken CLEMENTS, Los Gatos, CA (US); Owen RUBIN, Oakland, CA (US); Christina A. ENGEL, San Francisco, CA (US); Kendrick William JOHNSON, Woodinville, WA (US)

(21) Appl. No.: 15/161,098

(22) Filed: May 20, 2016

Related U.S. Application Data
(60) Provisional application No. 62/164,898, filed on May 21, 2015.

(51) Int. Cl. G06F 21/10; H04L 29/06

(52) U.S. Cl. CPC G06F 21/105; H04L 63/06; H04L 63/108; H04L 63/107; H04L 63/0428; H04W 4/008

(57) ABSTRACT

An apparatus, system, and method are described that permit the sharing of a temporary software license from a first computing device to a second computing device. A geographic distance limitation condition may be imposed as a condition for the sharing, such as a proximity range. More generally, the geographical distance limitation may be based around a local area network limitation. One application is to use the geographical distance limitation to permit temporary sharing of a temporary key for a multi-player game in which the players are within a pre-selected geographical distance limitation, such as a distance limitation corresponding to the players being in the same room, within a pre-selected maximum distance, or in the short range local area network.

### CROSS REFERENCE TO RELATED APPLICATIONS

The present application claims the benefit of U.S. provisional application No. 62/164,898, the contents of which are hereby incorporated by reference.

### FIELD OF THE INVENTION

The present invention is generally related to the temporary use of a software license, or other credentials, or other software objects extended to one or more third parties within a pre-selected geographical distance limitation. More particularly, an embodiment of the present invention is directed to supporting a mode of multiplayer gaming in which players that have authorized gaming software may provide a temporary license to other players interested in playing the multiplayer game.

### BACKGROUND OF THE INVENTION

FIG. 1 shows a typical prior art situation in which a friend visits to play a conventional board game. In this situation the two players are able to do so because one owns the board game, and the other comes to the same house such that they may play together. It may be that the first player owns the board game, or it is possible that the second player brought the game to the location.

However, many multi-player gaming scenarios cannot be conventionally implemented in advanced computer games without causing various social problems. In the example of FIG. 1, two small children are playing a conventional multiplayer board game. However, implementing a children's multiplayer board game as a computer game creates the problem that children do not typically have the money or authorization from their parents to buy software. Thus, if one child receives new multiplayer game software from his/her parents, other children may not immediately have the same software. This creates potential problems in game adoption. One child may, for example, receive a new multiplayer game software as a birthday present but none his/her playmates have compatible game software.

### SUMMARY OF THE INVENTION

This summary is provided to introduce a selection of concepts in a simplified form that are further described below in the detailed description. This summary is not intended to identify key features or essential features of the claimed subject matter, nor is it intended to be used to limit the scope of the claimed subject matter.

An embodiment of the present invention relates to the temporary use of a software license, or other credentials, or other software objects extended to one or more third parties. An exemplary application is in the context of multiplayer games, such as augmented reality (AR) or virtual reality (VR) multiplayer games.

An embodiment of the present invention comprising providing an authorized version of multiplayer game software to a first computing device and further providing a temporary license key to the first computing device distributable to other computing devices within a physical distance limit condition. The physical distance limit may be based on any condition associated with two computing device being co-located. This may include a physical distance measurement limitation. Another possibility for a physical distant limit condition is a short-range communication conditions between two communication devices, such as near-field electromagnetic, short-range infrared, optical, sound or other direct communication between two computing devices. Still another possibility for a physical distance limit condition is that two computing devices are communicating with each other via a short range network communication protocol, such as Bluetooth or WiFi. The temporary license key is communicated by a first communication device to a second communication device via a short range communication technique. The temporary license key is preferably transferred in an encrypted format.

The foregoing summary, as well as the following detailed description of illustrative implementations, is better understood when read in conjunction with the appended drawings. For the purpose of illustrating the implementations, there is shown in the drawings example constructions of the implementations; however, the implementations are not limited to the specific methods and instrumentalities disclosed. In the drawings:

### BRIEF DESCRIPTION OF THE DRAWINGS

FIG. 1 illustrates a typical pair of board game players in accordance with a conventional board game.

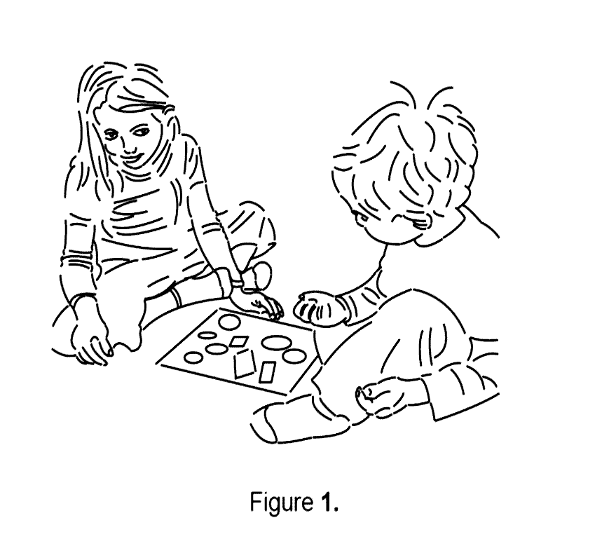

FIG. 2 illustrates an embodiment of a multiplayer game in which each player utilizes augmented reality to play a game in which the players are co-located within a physical distance limit condition, such as playing in proximity to each other about a virtual or physical game board, and a temporary license key is exchanged between computing devices.

FIG. 3A and 3B illustrate embodiments of a method of passing a temporary license key of co-located devices by using WiFi to confirm proximity and exchange the temporary license key.

FIG. 4 illustrates an embodiment of passing a temporary license key via optical symbols.

FIG. 5A illustrates an embodiment of passing a temporary license key by audio signals and FIG. 5B illustrates passing a temporary license key by infrared signals.

FIG. 6 illustrates an embodiment of activating transfer of a temporary license key by “bump.”

FIG. 7 illustrates an embodiment of a system for providing a temporary software license key to play a multiplayer game in accordance with an embodiment.

FIG. 8 illustrates an embodiment of a method to perform transfer of a temporary license key.

### DETAILED DESCRIPTION

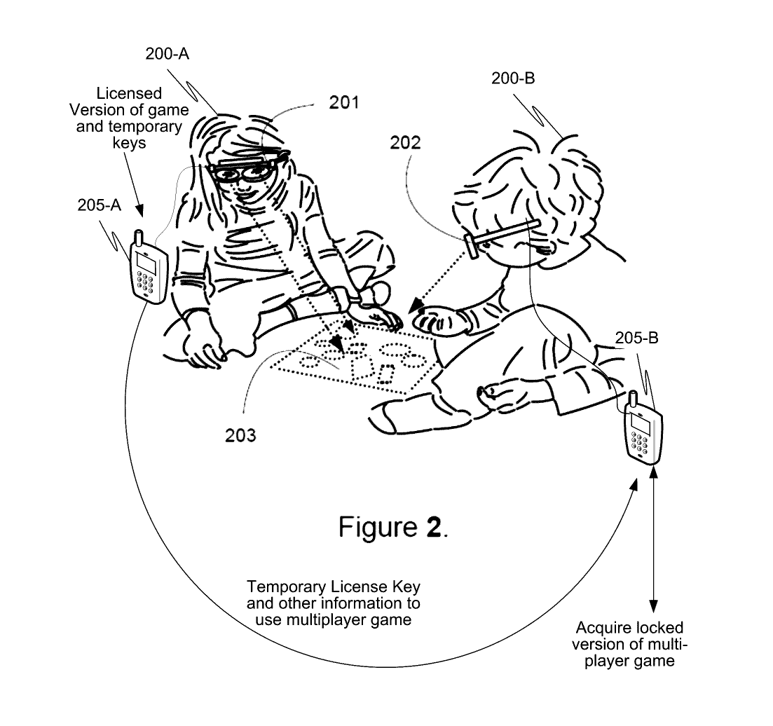

FIG. 2 illustrates the example of a multi-player augmented reality game. In FIG. 2, the situation is has been changed by the adoption of augmented reality (AR) technology such that both of the players have head mounted displays (HMD) 201, 202 that provide computer generated views of a gameboard and/or playing pieces 203 which may be implemented using a combination of physical objects and computer generated images (CGI) characters, to facilitate the play. The situation in FIG. 2 is that each player 200-A and 200-B in a multiplayer AR game may have his/her own individual HMD operating its own software, either directly, or via each user's separate respective portable computing devices 205-A and 205-B.

A drawback of the gaming environment of FIG. 2 is that each user is playing the game using his/her own HMD and respective computing device. This creates a potential problem of game compatibility. In one embodiment, a user's computing device, such as computing device 205-A includes a licensed version of a multiplayer game and one or more temporary license key(s). Another player, such as a player using computing device 205-B may initially have either a locked version of the same game or the potential to download a locked version of the game (e.g., via a website). However, user 200-B may not be able or willing to buy the key(s) to unlock the game. This may arise in a variety of contexts. For an adult user the user may be unwilling to purchase an unknown game. For a minor, the issues are more complex as in many circumstances a minor does not have a credit card to make online purchases and must make a special request to an adult or guardian to purchase a software game online Some game developers and marketers may see the added purchase requirement as a hindrance to product sales of multiplayer games, and thus may wish to grant temporary, or partial, license rights to the player who has not purchased the game, but wishes to play with someone who has a valid license. At the same time, such developers, in line with digital rights management (DRM) practices, would usually desire for the granting of temporary licenses to be sufficiently secure as to discourage abuse.

The individual portable computing devices 205-A and 205-B may include features originally developed for smart phones such as a display screen, camera, and a microphone. The individual portable computing devices 205-A and 205-B may also include a variety of different location detection and local signaling or communication features, such as near-field electromagnetic, an infrared signal generator, a local optical signaling interface, an infrared signal detector, an ultrasound signal detector, internal global positioning system location detection, a compass indicative of device orientation, a wireless network interfaces (e.g., Bluetooth or WiFi), motion sensors, and accelerometers.

In the example of FIG. 2, the computing device 205-A confirms that computing device 205-B satisfies a distance limit condition consistent with common multiplayer game scenarios in which players brings their own computing devices. Examples of a distance limit condition include a physical distance limitation and a short-range network condition from which geographical proximity is inferred, such as a Bluetooth communication link between computing devices 205-A and 205-B. Additional examples include confirming that the computing devices 205-A and 205-B are communicating within a local area wireless connection consistent within common multiplayer game scenarios such as a wireless connection with the same house, a coffee shop, or a recreational center. Other examples could include using available location data for each portable computing device 205-A and 205-B, such as global positioning system (GPS) data or data on location that can be determined using the wireless signals to and from each portable computing device.

The encryption of the temporary license key(s) stored on the first computing device 205-A may be based, in part, on data locally available to both computing devices. This may include information transferred from the second computing device to the first computing device, data associated with short-range communication links between the communication devices, data on local networks, or other local sensor data. Additionally, the temporary key may include distance limitations. In one embodiment, the temporary license key(s) are encrypted and part of the encrypted key(s) may include global positioning system (GPS) information for the devices such that the license is only valid while the difference between the GPS positions is less than a threshold value that represents the maximum allowed separation of players. Whereas an absolute GPS value may be appropriate for situations where the temporary license is only valid within a fixed distance of a fixed location (such as a school, museum or recreational facility) the relative difference limitation (hereinafter “delta GPS”) allows players to be co-located in moving vehicles such as cars, buses, trains, ships and aircraft.

In one embodiment, any necessary software to confirm co-location and implement the temporary key exchange is transferred as a software module from the first computing device 205-A to the second computing device 205-B. For example, a software module may be exchanged having the capability to encrypt and transfer internal global positioning system information providing the location information of the second computing device. As another example, software to transfer other location information, such as accelerometer data, may also be exchanged depending on implementation and what features are supported by the second computing device.

In the example of FIG. 2, multiplayer game interactions are supported. The temporary license key provides a certain degree of security based on the distance limitation condition. That is, the distance limitation between players roughly corresponds to a normal way in which people play multiplayer games in many social settings. Security is also provided by transferring the temporary license key(s) via s short range communication protocol between the computing devices 205-A and 205-B. Additional security is provided by encrypting the temporary license key prior to transfer. Additional layers of security can be provided, such as temporal limits on how long the temporary key is active, limits on the numbers and frequency of temporary keys that can be provided by an individual device to eliminate abnormal sharing indicative of attempts to steal game software, as well as an authentication step to perform a check that the other computing device has some indicia that it is computing device typical used for gaming

If desired, additional layers of security could be provided, such as embedding a tracking code into the temporary license key to track propagation of the temporary license key in the event that a malicious user tried to improperly distribute the temporary license key.

Each computing device 205-A and 205-B may be implemented in a variety of ways to include network interfaces to communicate with other computing devices. As example, they may be implemented as a hand-held computer or so called “smart phone.” Alternately, they may be implemented as special purpose devices to support AR/VR or be implemented using a smart phone platform specially adapted to support AR/VR such as by including a high speed link for an HMD. More generally, embodiments of the present invention are not limited to compact smart phones as the computing device but could also be implemented by plurality of game consoles or personal computers or other portable game systems, or a combination thereof. The game playing software may also be practiced by augmented reality or virtual reality system.

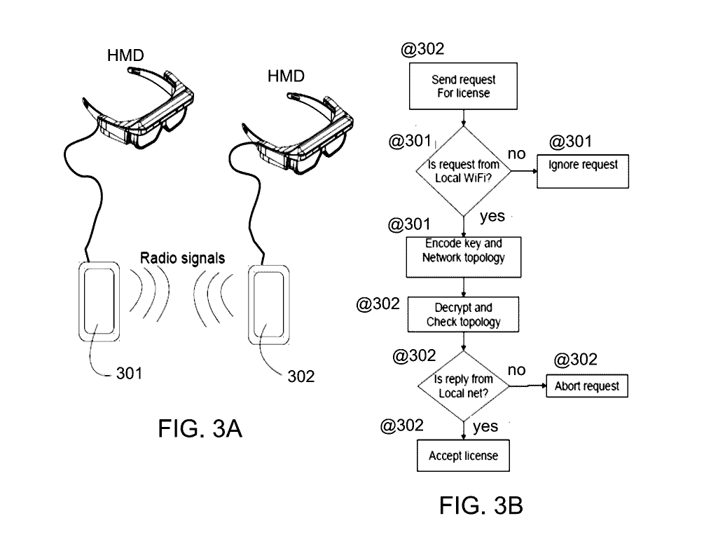

FIGS. 3A and 3B illustrate a use scenario in accordance with an embodiment. In this example the players are running software on smart phones 301 and 302. The phone 301 has the licensed software and generates an encrypted license key that is passed to the phone 302. In this embodiment the key exchange is over a WiFi connection between the phones, although in principle an effectively identical technique may be performed for a Bluetooth, or other wireless connection between the phones. As shown in the flow chart of FIG. 3B, phone 302 sends a request to phone 301 for a temporary license. The software in phone 301 checks packet headers to see if phone 302 is on the same ad hoc network or registered with the same WiFi access point. This network topology mapping is encrypted together with timestamps and authorization into an encrypted message that is sent back to phone 302. The game software in phone 302 then decrypts this message and checks that the encoded topology matches that seen from 302, and if so, authorizes and unlocks the game. A similar technique may involve local networking through Bluetooth technology (see Raithel et al. U.S. Pat. No. 6,772,331, hereby incorporated by reference).

Thus, in this example of FIG. 3B, the computing device 301 only shares the temporary key after it has confirmed that the intended receiving device is on the same short range network. The temporary key may also be also encrypted with the network topology information as an additional security measure. Computing device 302 may also check that it is receiving a temporary key from another device on the same short range network to minimize the possibility of computing device 302 being spammed or spoofed.

While an example has been provided of using the local network topology to encrypt the temporary key has been provided, more generally other information available to both devices may be used. Moreover, more elaborate protocols for the two computing devices to agree on an encryption protocol could be provided as software security measures operating in each computing devices.

The temporary license key(s) may be implemented in a variety of ways. In the software industry it is common to associate the granting of a limited use license with the generation and transfer of a so called “license key.” This is often in the form of an encrypted string of information that is cryptographically checked for validity by a copy of the software before operation. This technique allows the actual software to be copied from openly accessible sources, such as web sites, but not run without the proper key or keys. Keys may be made temporary by encrypting time stamps based on internal or external clocks such that algorithms may check to see if authorization is still in force as the software is running. Such techniques are well known to those of ordinary skill in the art. A time limit may be specified by a number of minutes, hour, or day after transfer. Alternatively, the time limit may be based on a number of minutes, hours, or days of total game play.

The authority to grant temporary licenses could be a free benefit granted to a person/device that has an authorized license to a game. Alternatively, a small surcharge could be charged for the privilege of granting temporary licenses.

The exchange of the temporary license key(s) may also be performed via a variety of different local communication techniques, including direct short-range device-to-device communication protocols in which two device form a direct communication link with each other. Moreover, the use of direct short range device-to-device communication protocols may also satisfy the physical distance limit condition. For example direct infrared communication between portable computing devices is generally short range. Similarly various ultrasound communication techniques to directly communicate between computing devices is short range. Various techniques for optical communication directly between two computing devices in free space is also typically short range in nature.

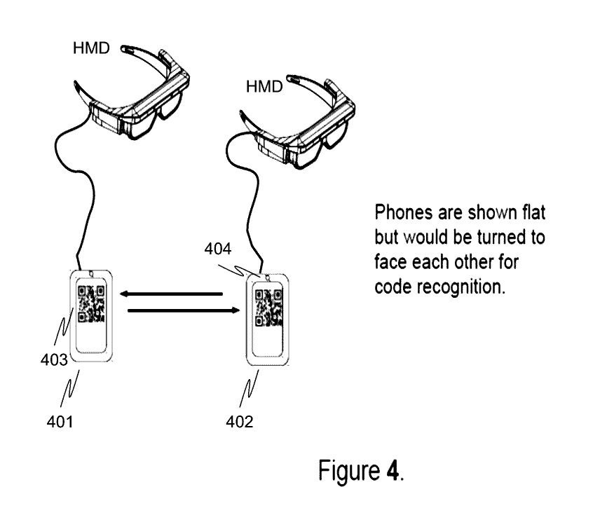

As alternate embodiment of the invention shown in FIG. 4. In this example, the the key exchange information may be facilitated by encoded optical patterns 403 that are presented on the screens of first phones 401 and read by cameras 404 on second phones 402, as is known by those skilled in the art of optical symbol scanners such as quick response (QR) codes (see Polk U.S. Pat. No. 8,296,477, hereby incorporated by reference). In the case of projected AR images, the code may be transferred by projected optics to be received by a camera or cameras in the second device. An advantage of optical transfer of encrypted key information is that it is short range and limited to line of sight, which improves security. The short range nature means the use of the technique satisfies a physical proximity condition. As in the previous examples, the temporary key may also optionally be encrypted with network topology information, if desired, to improve security. However, more generally, the temporary key could be encrypted with any information locally available to both computing devices.

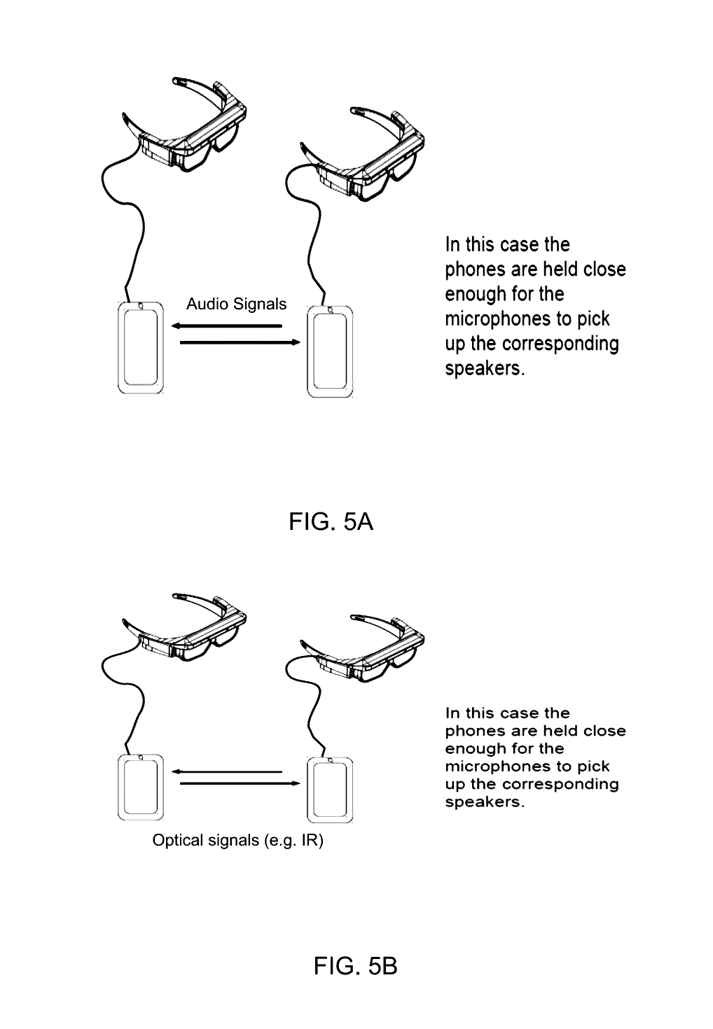

In a similar way, the exchange of the temporary license key(s) may be made by near field communication techniques using various short range direct communications between computing devices. For example, FIG. 5A illustrates audio signaling, such as exchanging the temporary key transmitted by audio tones from one phone to another, which may, for example, be within normal hearing human hearing or be ultrasound. FIG. 5B illustrates the use of optical signaling between computing devices, such as near infrared signaling. Moreover, any other close range communication techniques known in the art could be used to exchange the temporary license key(s). The use of a short range communication provides an additional layer of security. However, as in other examples, additional security techniques may be used to encrypt the temporary key based on any local information available to both computing devices.

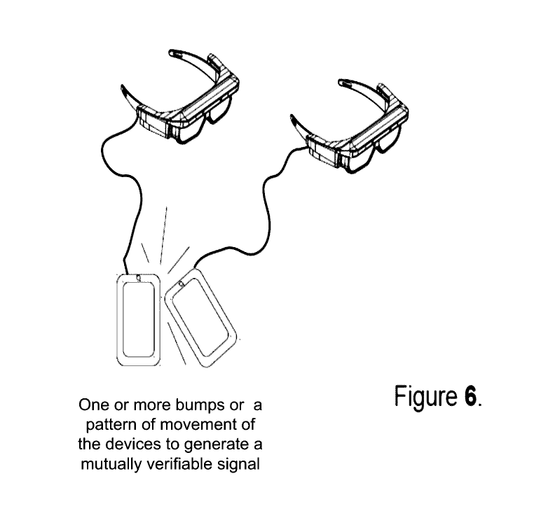

Another form of short range communication and/or proximity detection is physical contact of portable computing devices and/or coordinated physical movement. Devices equipped with accelerometers or other inertial/magnetic guidance units may use these facilities to verify co-location by “bump” as shown in FIG. 6 or holding the devices together and moving them through a pattern of motion that is registered together and communicated. Thus a bump (or a sequence of bumps) verifies co-location and may be used to trigger a transfer temporary license key(s). A sequence of coordinate movements or a pattern of movement may also be used to verify co-location. The sequence of bumps or pattern of movement may also be used to generate information for encrypting the temporary license key, such as by using the timing between bumps or the velocity and acceleration of the pattern of movements as information to encrypt the key(s). For example, if two computing devices are bumped in a sequence (e.g., bump 1, bump 2, and bump 3, then there will be time gaps between bumps that can be recognized on each computing device and used for encryption/decryption purposes).

It will also be understood that more than one technique may be utilized in combination to verify co-location. For example, two computing devices could exchange GPS data and also data on network topology with co-location being verified via a combination of the techniques. Moreover, in some environments, such as underground buildings, GPS signals may be unavailable. Thus, there may be practical reasons to include a primary co-location detection technique and one or more backup co-location detection techniques in case a primary co-location technique fails.

As yet another example an electric or magnetic signal similarity may also be used to verify co-location. Two computing devices that are co-located are likely to experience similar magnetic signals, electric signals, and electromagnetic signals. For example, a magnetic sensor on each computing device may calculate the local magnetic field (strength and orientation) and transfer this information to the other device. Two computing devices in close proximity are also likely to experience similar strength of given frequency of wireless LAN signals, regardless of whether a particular frequency is used to communication between the two devices Similarly, the strength of local signals not related to wireless links between the two devices may be considered (e.g., local AM signals not related to wireless links between devices) may also be transferred to confirm that both devices receive similar electromagnetic signals.

In one embodiment optical recognition of physical objects or labels is performed by one or both of the computing devices. For example, in a game environment a game board 203 may have physical objects or labels that can be identified (e.g., the shape of a “checker” in check board or labels on the checkerboard or the game pieces). More generally, the shape of any local object may be identified and used as additional information for authentication or as a source of information to encrypt the temporary license key. As an example, if two people are playing a game, an instruction could be given to snap a picture of a common object in view of both players. Information obtained from the object could, in turn, be used to aid in encrypting the temporary license key and performing any necessary decryption. Moreover, the object/label recognition could also be performed as a step or sub-step in confirming co-location. For example, if the game board 203 has a secret code or code label embedded in it, then the second device should be able to receive instructions to take a photo to provide information derivable from the game board 203 and any associated game objects.

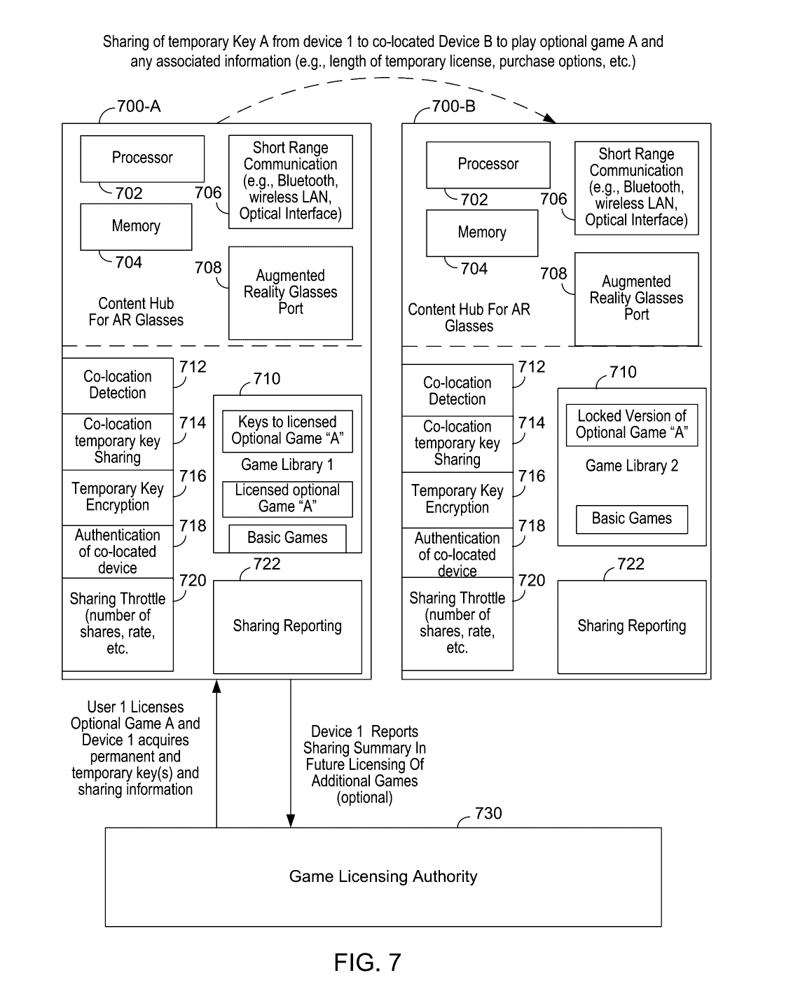

FIG. 7 illustrates an example of an embodiment in which each computing device 700 has a processor 702, memory 704, short range communication 706, and a port or other communication interface 708 to support communication with a HMD, such as AR HMD or a VR HMD. Each computing device includes a local game library 710, e.g., software game programs stored as instructions on a local storage medium. This may includes basic games. In this example, computing device 700-A also has a licensed version of Game “A” and any associated temporary keys. Computing device 700-B initially has either a locked version of Game “A” or may download a locked version of game “A”, such as via an Internet website.

A variety of features may be implemented in firmware or software (residing on a local memory in the computing device) to support sharing of temporary keys. In one embodiment, a co-location detection module 712 performs the steps associated with verifying that two computing devices are co-located within a short range network condition or other proximity condition. A co-location temporary key sharing module 714 performs the steps associated with sharing a temporary key, which may be performed in combination with any encryption/decryption. This may be supported by a temporary key encryption/decryption module 716. In principle, if each computing device has compatible firmware or software, an authentication code may be stored on each computing device an authentication module 718 as an additional optional security measure. This additional security code could be exchanged to verify each computing device to each other. An optional throttling module 720 may be included to limit the number and rate of sharing of temporary licenses to provide a barrier to large scale improper sharing. For example, the number of shares per day may be limited to some total number per day consistent with typical ordinary multiplayer game use. Limits on the total numbers of shares per week or month may also be supported. Alternatively, sharp increases in the rate of sharing may also be limited. An optional reporting module 722 may be included to report instances of sharing. For example, when device 700-A licenses a new game from a licensing authority 730 a report may be generated showing the history of sharing of previous games licensing to device 700-A.

In the embodiment of FIG. 7 it will also be understood that each computing device 700 may include a display, camera, microphone, accelerometer, magnetic and electric sensors, compass, GPS or other features that may be used to generate location information or exchange temporary key information using any of the above-described techniques.

In one embodiment, the authentication module 718 utilizes RFID technology in which each authentication module 718 includes a reader portion, an ID portion and an RF antenna to support short range RFID. Short range RF signals are then used for each computing device 700 to perform RF identification of another nearby computing device as a security measure.

Moreover, it will be understood that the authentication process could also employ servers for a portion of the authentication process, such as using an external server to provide temporary codes. It will also be understood that more elaborate protocols for the two computing devices to agree on an encryption protocol could be provided as software security measures operating in each computing device, or may be facilitated through one or more servers located on an external network or server cloud.

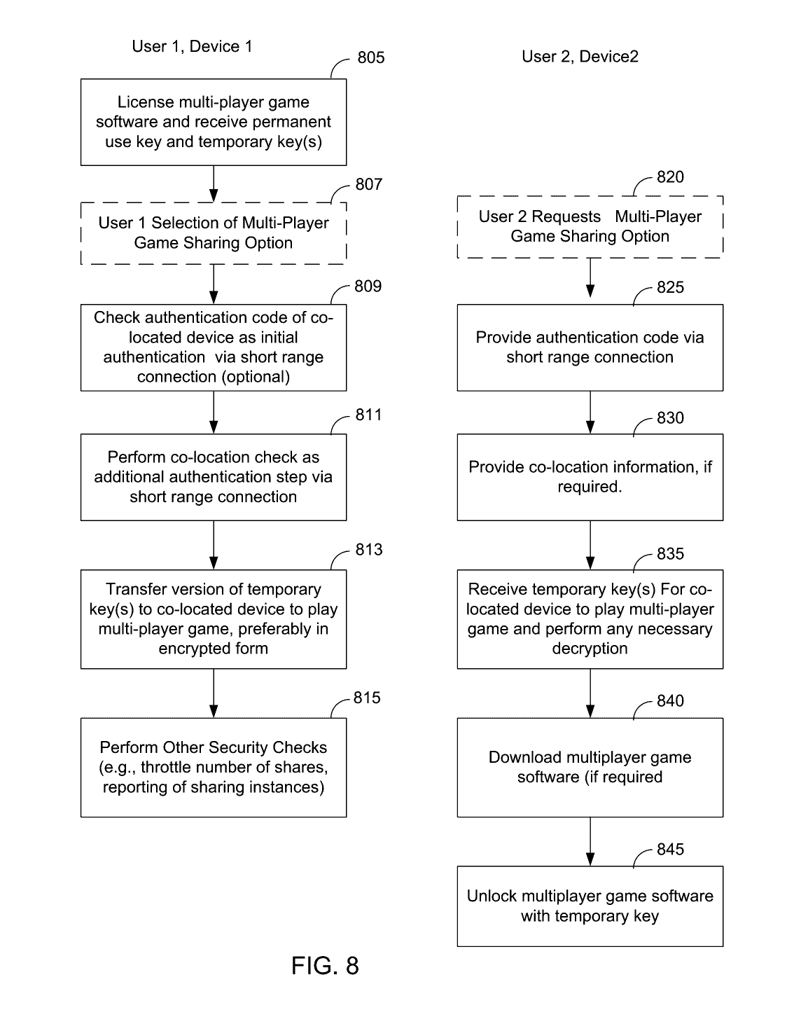

FIG. 8 illustrates examples of flowcharts of operation for actions at a first user device 1 sharing a temporary key with a second user device. At some initial time, the first user device licenses 805 a multiplayer game software and also receives the temporary key(s) to unlock the game. In one use scenario, user 1 would select a multi-player game sharing option 807. An optional authentication step 809 is performed to verify an authentication code of the other device. A co-location check 811 is performed to confirm the other computing device is within some distance/range limitation based on any of the previous techniques described above. A transfer is performed of temporary key(s) to the co-located device 813. This transfer may include transfer the temporary key(s) in an encrypted form. Other optional security checks 815 may be performed, such as verifying that the sharing of the transfer key does not exceed a rule on the number or rate at which temporary keys are shared.

FIG. 8 also illustrates steps performed at the second computing device. In one optional implementation, the second user requests the multi-player game sharing option 820. If an authentication step is performed, the second device provides an authentication code via a short range connection. The second device, depending on implementation, may provide co-location information 830, such as via optical, infrared or sonic signals. The second device received the temporary key(s) 835 and performs any necessary decryption. If not previously performed, the second device may download a locked version of the multiplayer game software 840. This may be facilitated by, for example, the first computing device sending information on an Internet address to obtain the locked version of the game software. This additional information may, for example, be transferred along with the temporary key. The second device then unlocks 845 the multiplayer game software using the temporary key.

One aspect of an embodiment of the present invention is that the transfer of a temporary key does not require long distance telecommunication means. In some game environments, such communication means may even be unavailable or unreliable, such as when games play occurs in remote locations with intermittent or poor access to the Internet over long distance wireless cellphone connections. Moreover, providing the temporary key by a short range local communication technique improves security. Limiting the exchange of the temporary keys to a short distance technique provides for the exchange of keys by means that are physically limited to short distances and are reasonably difficult to “spoof” by recording and replaying or transmitting over communication networks.

In some embodiments the temporary license, once granted, may allow separation or “standalone” play for limited time intervals. This may extend to sessions that, for a limited time, are allowed to continue over telecommunication networks. The former case covers situations in which players come together to start a game, but then wish to finish after physically separating. Furthermore, the granting device may host network proxy (or other) services, extended to the temporary device although separated after initial grant.

In one embodiment, additional confirmation of the co-location condition may be performed. For example, the temporary license may be set to have a very short time duration with periodic reactivation being required in order to renew the license key and allow continuing software activation. Setting a short effective temporary license key is an additional optional security mechanism. For example, if reactivation is required every few minutes it provides an additional technique to limit improper distribution of the temporary license.

In one embodiment, a supplier would sell the computing devices customized to support the co-location detection and sharing of temporary license keys. In other embodiments, software necessary to implement the features could be downloaded onto a computing device from a website or supplied from another portable computing device.

While an exchange of a temporary key has been described, more generally any another information needed to play the game may also be exchanged. In some embodiments, physical objects (“tangibles”) may be part of a game set, and copyright holders may wish to include the optical recognition of the tangible or decoding of labels on said tangibles by the visiting device as a part of the authorization process, or temporary lending of digital assets such as game characters to the visiting device.

In some embodiments the intellectual property owner may wish to condition the software to make a purchase offer to the visiting player at the time of, or after, the termination of said temporary license or shared software object. The offer may be for the shared game or object or may be for other associated products, and may include discounts or other incentives and/or limitations. For example, the offer information may be transferred with the temporary key. As an illustrative example, suppose the temporary key has a time limit of 30 days of free play. Information on the time limit and an offer or discounted offer to purchase a full license may also be provided to device receiving the temporary key.

Although an example has been described in which the computing device is separate from the HMD, it will be understood that there are techniques to use a special holder to convert the camera and display of a smart phone into an augmented reality display. Thus, it will be understood that embodiments of the present invention may be practiced on individual smart phones without additional HMDs. However, it will also be understood that embodiments are contemplated in which each computing device is specially adapted and devoted to AR applications.

While examples have been described for AR application, it will be understood that more generally other types of multiplayer games may be supported, such as virtual reality games.

An illustrative embodiment has been described by way of example herein. Those skilled in the art will understand, however, that change and modifications may be made to this embodiment without departing from the true scope and spirit of the elements, products, and methods to which the embodiment is directed, which is defined by our claims. Specifically, although the above description has been written in terms of a two player game or item of software, this is not an intended limitation of the invention and those of ordinary skill in the art will understand that the invention may be extended to comprise multiple players or software users or indeed some number of human users and some number of automated opponents. Furthermore, although the disclosure is primarily directed to playing computer assisted or augmented games, those of ordinary skill in the art will understand that the invention may facilitate the granting of temporary use licenses, or similar credentials, for any software product, without limitation.

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention. In accordance with the present invention, the components, process steps, and/or data structures may be implemented using various types of operating systems, programming languages, computing platforms, computer programs, and/or computing devices. In addition, those of ordinary skill in the art will recognize that devices such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

What is claimed is:

1. A method of providing a temporary software license key, or other software objects, for a multi-player computer game comprising:
(a) receiving, at a first computing device, a software license authorizing the first computing device to play a multi-player game and further authorizing the first computing device to share a temporary license key for the multi-player game with other co-located computing devices within a range of the first computing device satisfying a distance limit condition;
(b) establishing communication with a second computing device using a short range communication protocol;
(c) establishing, by the first computing device, that the physical location of the second computing device is within the distance limit condition; and
(e) providing to the second computing device the temporary license key for the second computing device to unlock the multi-player game.

2. The method of claim 1, wherein the temporary license key is provided to the second computing device in an encrypted format.

3. The method of claim 1, wherein establishing the physical location of the second computing device being within the distance limit condition, comprises checking that the second computing device is connected to the first computing device via a short range wireless technology.

4. The method of claim 3, wherein the short range wireless technology is Bluetooth and the method comprises determining that a Bluetooth connection exists between the first computing device and the second computing device.

5. The method of claim 3, wherein the short range wireless technology is WiFi and the method comprises determining that a WiFi connection via a common WiFi network exists between the first computing device and the second computing device.

6. The method of claim 3, wherein the short range wireless technology is a local area communication network and the method comprises establishing that the first communication device and the second communication device are communicating via a wireless local area network with the same wireless access point as the first computing device.

7. The method of claim 3, wherein the short range wireless technology is RFID.

8. The method of claim 1, wherein establishing the physical location of the second computing device is within the distance limit condition comprises presenting optical coded patterns on the screen of the first computing device to be received and detected at the second computing device.

9. The method of claim 1, wherein establishing the physical location of the second computing device is within the distance limit condition, comprises transmitting coded audio signals from the first computing device to be received at the second computing device by a microphone.

10. The method of claim 1, wherein establishing the physical location physical location of the second computing device is within the distance limit condition, comprises:
(a) receiving, from the second device recorded acceleration and/or magnetic field recording indicative of a location of the second device; and
(b) the first computing device calculating the difference location of the second device with respect to acceleration and/or magnetic field recording of the first computing device.

11. The method of claim 1, further comprising periodically confirming the second device is within the distance limit condition as a condition required to renew the temporary license key for continued software activation.

12. The method of claim 1 wherein the temporary license key allows limited periods of separation or standalone operation of the software on the second computing device.

13. The method of claim 1, further comprising the optical recognition of physical objects or labels by one or both of the computing devices to obtain information to construct the temporary license key.

14. A method of providing a multi-player game, comprising:
providing an authorized version of a software game to a portable computing device; and
providing a temporary license key to the portable computing device and co-location distribution rules for the portable computing device to distribute to other computing devices the temporary license key subject to the portable computing device implementing a co-location test in which the temporary license key is distributed only to other portable computing devices satisfying a location distance condition.

15. A system for providing a temporary software license key, or other software objects to play a multiplayer game, comprising:
a first computing device having licensed software authorized for playing a multiplayer game and an associated temporary license key to temporarily unlock a locked version of the multiplayer game, the first computing device configured to;
(a) detect a second computing device proximate the first computing device corresponding to satisfying a physical limit condition;
(c) establish a local communication link with the second computing device to transfer the temporary license key with the second computing device to play a multiplayer game;
(d) transfer the temporary license key to the second computing device via the local communication link to enable the second computing device to unlock the multiplayer game; and
(e) play the multiplayer game with the second computing device.

16. The system of claim 15, wherein the first computing device is configured to encrypt the temporary license key prior to transferring it to the second computing device.

17. The system of claim 15, wherein the first computing device determines whether or not the second physical device is within a pre-selected physical distance as the physical limit condition.

18. The system of claim 15, wherein the first computing device determines whether or not the second computing device is communicating with the first computing device via a limited area network protocol.

19. The system of claim 15, wherein the limited are network protocol comprises one of Bluetooth, WiFi, RFID, or a local area wireless network protocol.

20. The system of claim 15, wherein the first computing device verifies physical proximity satisfying the physical limit condition via at least one of detecting physical contact of the first computing device and the second computing device.

21. The system of claim 15, wherein the local short range communication for transferring the temporary license key comprises at least one of sonic signals, infrared signals, optical character symbols generated by one device and detecting by another.
